(19) United States
(12) Patent Application Publication
(10) Pub. No.: US 2026/0336351 A1
(43) Pub. Date: Oct. 29, 2026

(54) TWIN-RESERVOIR SHOCK ABSORBER WITH MULTI-RATE DAMPING

(71) Applicant: Polaris Industries Inc., Medina, MN (US)

(72) Inventors: Randall C. Anderson, Riverside, CA (US); Brian MacLean, Jurupa Valley, CA (US)

(21) Appl. No.: 19/550,993

(22) Filed: Feb. 26, 2026

Related U.S. Application Data
(60) Provisional application No. 63/766,049, filed on Mar. 3, 2025.

(51) Int. Cl. B60G 17/08; B60G 15/06; B62D 21/11

(52) U.S. Cl. CPC B60G 17/08; B60G 15/062; B62D 21/11; B60G 2202/242; B60G 2202/312; B60G 2206/41; B60G 2300/07

(57) ABSTRACT

A twin-reservoir shock absorber, including: a shock body defining a shock-body fluid chamber; a shaft insertable into the shock-body fluid chamber; a piston connected to an end of the shaft; a first damping system including a first reservoir body and first floating piston, the first damper housing defining a first reservoir having a first variable-volume reservoir portion in fluid communication with the shock-body fluid chamber, and a second variable-volume reservoir portion reservoir filled with a first gas; a second damping system including a second reservoir body and a second floating piston, the second damper reservoir body defining a second fluid reservoir including a third variable-volume reservoir portion in fluid communication with the shock-body fluid chamber and a fourth variable-volume reservoir portion filled with a second gas; and a spring extending over a portion of the shock body.

### RELATED APPLICATIONS

This application claims the benefit of priority to U.S. Provisional Application Serial No. 63/766,049, filed Mar. 3, 2025, the content of which is incorporated herein by reference in its entirety.

### BACKGROUND

Powersports vehicles, such as side-by-side off-road vehicles, all-terrain vehicles, utility vehicles and off-highway motorcycles typically include suspension systems with shock absorbers to dampen spring action and assist in maintaining control of the powersports vehicle. Various types of shock absorbers for powersports vehicles are known and may include damping systems with reservoirs with oil or gas that may be adjustable to suit road or trail conditions or driver preference. However, such known shock absorbers fail to provide optimal off-road damping, and ultimately optimal handling, when operated on particularly rugged terrain where the suspension system of the powersports vehicle is subjected to sudden, forceful shocks.

### SUMMARY

Embodiments of the present disclosure include a twin-reservoir shock absorber with a first damping system and a second damping system that provide dual-rate damping. The first damping system with its first reservoir allows low damping to create a softer vehicle ride. The second damping system with its second reservoir provides increased damping and is used for more significant suspension events. With its two damping systems, embodiments of the twin-reservoir shock absorber of the present disclosure allow for a vehicle suspension setup that yields a soft ride and handling but that also absorbs significant suspension events.

One embodiment of the present disclosure is a twin-reservoir shock absorber that includes: a shock body defining a longitudinally-extending shock-body fluid chamber; a shaft insertable into the shock-body fluid chamber, the shaft having a first end and a second end; a piston connected to the first end of the shaft and longitudinally moveable within the shock-body fluid chamber; a first damping system including a first reservoir body and a first floating piston in the first reservoir body, the first reservoir body defining a first reservoir, the first reservoir having a first variable-volume reservoir portion in fluid communication with the shock-body fluid chamber, and a second variable-volume reservoir portion reservoir filled with a first gas, the first floating piston separating the first variable-volume reservoir portion from the second variable-volume reservoir portion; a second damping system including a second reservoir body and a second floating piston in the second reservoir body, the second reservoir body defining a second fluid reservoir, the second fluid reservoir including a third variable-volume reservoir portion in fluid communication with the shock-body fluid chamber and a fourth variable-volume reservoir portion filled with a second gas, the second floating piston separating the second variable-volume fluid reservoir from the second variable-volume gas reservoir; and a spring extending over a portion of the shock body.

Another embodiment of the present disclosure is a multirate shock absorber system that includes: a shock body assembly, including a shock body defining a shock-body fluid chamber filled with a liquid fluid, a shaft moveable within the shock-body fluid chamber, a main piston assembly and a check valve connected to the shaft, and a spring coupled to the shock body; a first damping system in fluid communication with the shock-body assembly, the first damping system configured to dampen movement of the spring according to a first damping rate of the first damping system; and a second damping system in fluid communication with the shock-body assembly, the first damping system configured to dampen movement of the spring according to a second damping rate of the second damping system, the first damping rate being greater than the second damping rate.

Yet another embodiment of the present disclosure is a powersports vehicle that includes: a vehicle body; a plurality of ground-engaging members; a power source connected to a transmission for propelling the powersports vehicle, a suspension system including a plurality of twin-reservoir shock absorbers; and a frame supporting the vehicle body, power source and transmission, and suspension system. Each twin-reservoir shock absorber of the plurality of shock-absorbers includes: a shock body defining a longitudinally-extending shock-body fluid chamber; an axially-extending shaft insertable into the shock-body fluid chamber, the shock shaft having a first end and a second end; a piston connected to the first end of the shaft and longitudinally moveable within the shock-body fluid chamber; a first damping system including a first reservoir body defining a first reservoir and a first floating piston in the first reservoir, the first damping system configured to provide a first shock damping effect; and a second damping system including a second reservoir body defining a second reservoir and a second floating piston in the second reservoir, the second damping system configured to provide a second shock damping effect that is different from the first shock damping effect.

### BRIEF DESCRIPTION OF THE DRAWINGS

The disclosure can be understood in consideration of the following detailed description of various embodiments in connection with the accompanying drawings.

FIG. 1 is a perspective view of a powersports vehicle with twin-reservoir shock absorbers, according to an embodiment of the present disclosure.

FIG. 2 is a front view of an embodiment of a twin-reservoir shock absorber, according to an embodiment of the present disclosure.

FIG. 3 is a top view of the twin-reservoir shock absorber, with a cutting plane line indicating the view of FIG. 4.

FIG. 4 is a sectional view of the twin-reservoir shock absorber of FIGS. 2-3 in a partially compressed state, according to an embodiment of the present disclosure.

FIG. 5 is a top view of the twin-reservoir shock absorber, with a cutting plane line indicating the view of FIG. 6.

FIG. 6 is a sectional view of a first damping system and a second damping system of the twin-reservoir shock absorber of FIG. 2.

FIG. 7 is another sectional view of the twin-reservoir shock absorber of FIG. 2, depicting the twin-reservoir shock absorber at the start of a compression stroke in a first damping zone, according to an embodiment of the present disclosure.

FIG. 8 is another sectional view of the twin-reservoir shock absorber of FIG. 2, depicting the twin-reservoir shock absorber during a second damping zone of a compression stroke, according to an embodiment of the present disclosure.

FIG. 9 is another sectional view of the twin-reservoir shock absorber of FIG. 2, depicting the twin-reservoir shock absorber during a third damping zone of a compression stroke, according to an embodiment of the present disclosure.

FIG. 10 is another sectional view of the twin-reservoir shock absorber of FIG. 2, depicting the twin-reservoir shock absorber during a fourth damping zone of a compression stroke, according to an embodiment of the present disclosure.

FIG. 11 is another section view of the twin-reservoir shock absorber of FIG. 2, depicting the twin-reservoir shock absorber during a rebound stroke.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

Embodiments of the present disclosure include a twin-reservoir shock absorber with a first damping system and a second damping system that provide dual rate damping. The first damping system with its first reservoir allows low damping to create a softer vehicle ride. The second damping system with its second reservoir provides higher damping and is used for more significant suspension events. With its twin-damping systems, embodiments of the twin-reservoir shock absorber of the present disclosure allow for a vehicle suspension setup that yields a plush but that also absorbs significant suspension events.

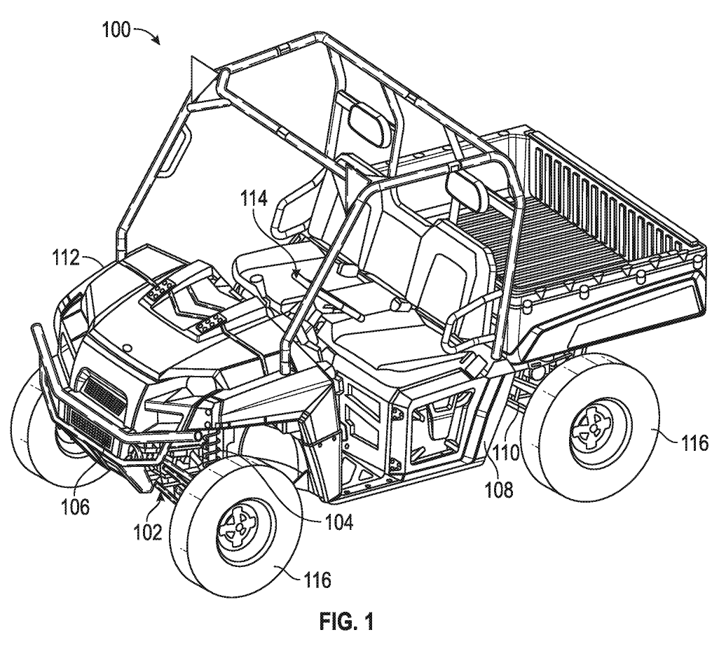

Referring to FIG. 1, an illustrative embodiment of a powersports vehicle 100 is depicted. Although vehicle 100 is depicted as a side-by-side off-road vehicle (ORV), it will be understood that vehicle 100 may comprise any of a variety of powersports vehicles whose primary purpose is to travel on terrain other than paved roadways, and includes vehicles such as all-terrain vehicles (ATVs), side-by-side or utility terrain vehicles (UTVs), off-highway motorcycles (OHMs), snowmobiles, and similar such vehicles.

Vehicle 100 as illustrated includes suspension system 102 with a plurality of twin-reservoir, multirate-damping shock absorbers 104 (hereinafter “twin-reservoir shock 104”), as well as power source 106, transmission 108, frame 110, body 112, steering system 114, and ground-engaging members 116.

Suspension system 102, in addition to twin-reservoir shocks 104 (described further below), may also include suspension arms, ball joints, sway bars, and so on, depending on the particular type of vehicle and intended use. Suspension system 102 maintains friction between ground engaging members 116 and the ground surface upon which vehicle 100 is operated, providing stability to vehicle 100 and comfort for an operator of vehicle 100.

Power source 106 may comprise one or more of a variety of different power sources, such as a combustion engine, electric motor, hybrid-electric motor, and so on.

Frame 108 supports the various mechanical components of vehicle 100, including suspension system 102, power source 106, transmission 108, body 112, and steering system 114.

Transmission 110, when present, is in mechanical connection to power source 106, and in particular to a combustion engine. Transmission 110 is configured to transfer power from power source 106 to ground-engaging members 116.

Body 112 may comprise a plurality of panels connected to frame 108 and configured to protect the various components of vehicle 100 and the operator and passengers of vehicle 100.

Steering system 114, in an embodiment, is configured to allow an operator of vehicle 100 to control and direct vehicle 100, and may include a steering wheel, as depicted in FIG. 1, or may include handlebars of other means for interfacing with an operator.

Ground engaging members 116 may comprise wheels with tires, as depicted, or alternatively, may include tracks, skis and so on. Ground-engaging member 116, particularly in the case of wheels and tires, may be coupled to power source 106 via transmission 110 to power movement of vehicle 100.

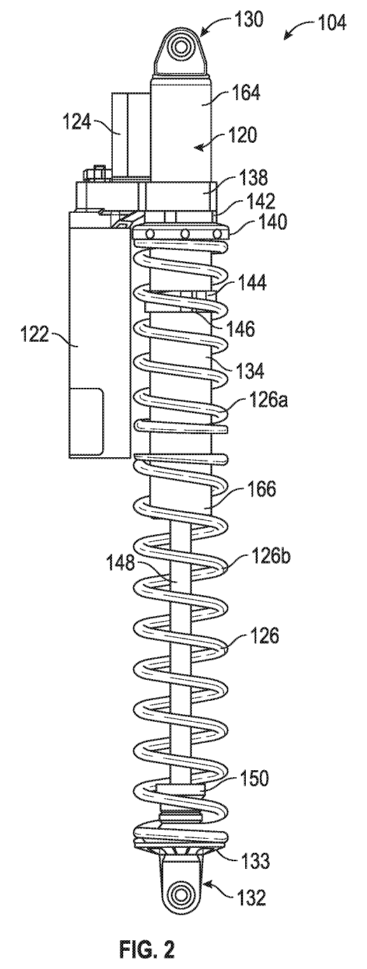

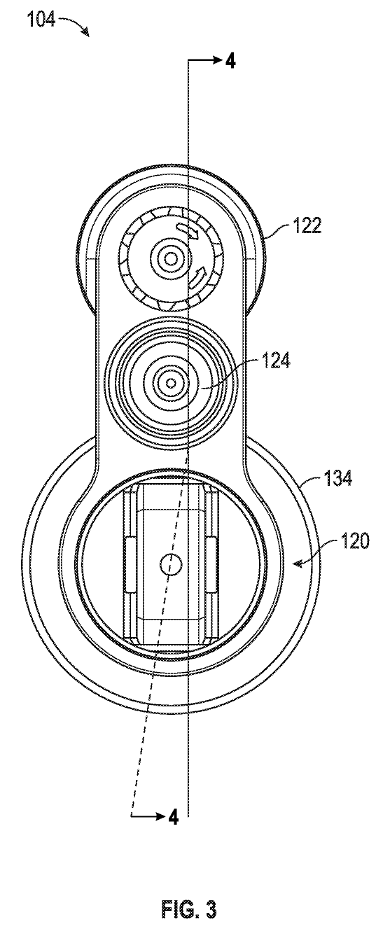

Referring to FIG. 2, a front view of an embodiment of twin-reservoir shock 104 is depicted, and referring also to FIG. 3, a top view of twin-reservoir shock 104. In an embodiment, twin-reservoir shock 104 includes shock body assembly 120, first damping system 122, second damping system 124 and spring 126.

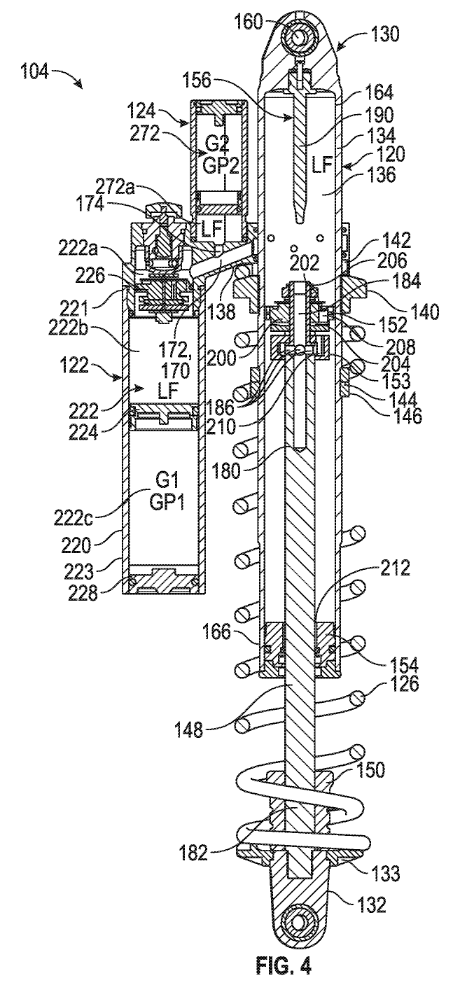

Referring also to FIG. 4, which is a sectional view of twin-reservoir shock 104, in an embodiment, shock body assembly 120 includes first or upper end 130, second or lower end 132 with spring retainer 133, shock body 134 defining shock-body fluid chamber 136, bridge portion 138, spring nut 140, first crossover ring 142, second crossover ring 144, third crossover ring 146, shaft 148, bump stop 150, main piston assembly 152, check valve 153, wiper-seal assembly 154 and first or main needle assembly 156. It will be understood that while crossover rings 142, 144 and 146 are depicted in this embodiment, other embodiments may not include crossover rings.

In an embodiment, and as depicted, first end 130 defines opening 160 and is configured to mount to a chassis or body of vehicle 100; second end 132 defines opening 162 is configured to mount to vehicle 100, such as at another portion of the suspension system. Spring retainer 133 is configured to retain or hold spring 126 over shaft 148 and shock body 134.

Shock body 134 extends longitudinally, or in an upper-to-lower direction, and forms a generally cylindrical shape, defining shock-body fluid chamber, which is a generally hollow, cylindrical chamber filled with a liquid damping medium or fluid (hereinafter referred to as “liquid fluid LF”), such as hydraulic oil. Shock body 134 includes upper end 164 and lower end 166. In an embodiment, shock body 134 comprises a rigid material, such as a metal but in other embodiments may comprise other materials. Shock body 134 and shock-body fluid chamber 136 is closed or sealed at upper end 164, and defines an opening at lower end 166 which is sealed with wiper-seal assembly 154.

Wiper-seal assembly 154 defines a central shaft-receiving opening through which shaft 148 is configured to travel during compression and rebound strokes of twin-reservoir shock 104.

Bridge portion 138 bridges or joins shock body 134 to first damping system 122 and second damping system 124. As seen specifically in FIG. 4, bridge portion 138 defines bridge channel or port system 170 that includes one or more first bridge channels 172 and one or more second bridge channels 174. In an embodiment, and as depicted, second bridge channel 174 is in communication with first bridge channel 172, extending transversely from first bridge channel 172. Bridge channel system 170 fluidly connects shock body assembly 120 to first and second damping systems 122 and 124. More specifically, shock-body fluid chamber 136 is in fluid communication with first reservoir 222 of first damping system 122 via first bridge channel 172, and shock-body fluid chamber 136 is in fluid communication with second reservoir 272, including third variable-variable volume reservoir portion 272a via first bridge channel 172 and second bridge channel 174.

Bridge portion 138 may be an integral structure, such as depicted, or may comprise a plurality of bridge portions joined together.

Spring nut 140 may comprise circular or disk-shaped nut affixed, or movably affixed, to shock body 134. Spring nut 140 retains an upper end of spring 126.

Crossover rings 142, 144 and 146, when present, may be movably affixed to an outer surface of shock body 134, and may be positioned to affect and control compression of spring 126 in an embodiment where spring 126 comprises a pair of springs. As depicted, spring 126 is a coil-over spring, and may comprise a dual-rate spring with a pair of springs, upper spring 126a positioned above lower spring 126b to form a dual-rate spring configuration, as will be understood by those of ordinary skill in the art. Shock absorbers with crossover rings and dual-rate springs are depicted and described in U.S. patent Publication No. US 2024/0246380A1 entitled “Shock Absorber Crossover Bumper,” filed on Jan., 18, 2024 and owned by the present Applicant, which is incorporated by reference herein in its entirety.

Shaft 148 includes first or upper end 180 which is attached to main piston assembly 152 and second or lower end 182 at lower end 132 twin-reservoir shock 104. Shaft 148 extends longitudinally, and as described further below, is configured to travel vertically or longitudinally during compression and rebound of twin-reservoir shock 104. Shaft 148 extends through wiper-seal assembly 154, with upper portion 180 remaining within shock-body 134 and lower portion 182 remaining outside of shock body 134.

In an embodiment, shaft 148 at first end 180 defines hollow needle-receiving channel 184 configured to receive needle 190 of needle assembly 156 such that needle 190 contacts in inside surface of shaft 148 that forms a needle seat.

First end 180 of shaft 148 also defines a plurality of fluid ports 186 in fluid communication with needle-receiving channel 184 at upper end 180. Fluid ports 186 define openings or channels in shaft 148 that extend transversely to needle-receiving channel 184. In an embodiment, shaft 148 may define four shaft fluid ports 186 (three are visible in FIG. 4), though other quantities of fluid ports 186 are contemplated. Each fluid port 186 is also in fluid communication with check valve 153, as described further below.

Bump stop 150 is connected to second end 182 of shaft 148 and forms a cushion between shock body 134 with wiper-seal assembly 154 and a terminal, second end 132 of shock body assembly 120.

Main piston assembly 152, in an embodiment, includes piston body 200, one or more rebound shims (valves) 202, one or more compression shims 204 and piston-shaft nut 206.

Piston body 200 may be a single, integrally formed structure defining one or more piston ports 208, including one or more compression ports and one or more rebound ports in fluid communication with shock-body fluid chamber 136, configured for fluid flow through piston body 200.

The one or more compression shims 204 are flexibly mounted to an upper end of piston body 200, movably covering upper ends of piston ports 208, while the one or more rebound shims 204 are flexibly mounted to a lower end of piston body 200 movably covering lower openings of ports 208.

Main piston assembly 152 is coupled to first end 180 of shaft 148 and held in place with piston-shaft nut 206 connected to a threaded end of shaft 148.

Check valve 153 is positioned beneath main piston assembly 152 and is also coupled to shaft 148. Check valve 153 defines one or more check valve ports 210 in fluid communication with shock-body fluid chamber 136 and needle-receiving channel 184 via shaft fluid ports 186.

Wiper-seal assembly 154 is position at second end 166 of shock body 134, sealing shock body 134 and shock-body fluid chamber 136. Wiper-seal assembly 154 defines a central opening 212 that receives shaft 148.

Embodiments of shock absorbers containing similar components are described and depicted in U.S. Patent No. US 8,820,495, issued Sep. 2, 2014, “Adjustable Internal Bypass Shock Absorber Feature a Fluid Flow Regulator,” assigned to King Shock Technology, Inc., which is herein incorporated b reference in its entirety.

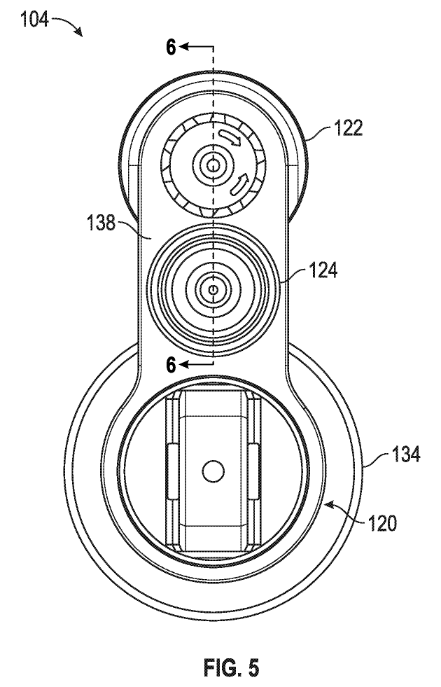

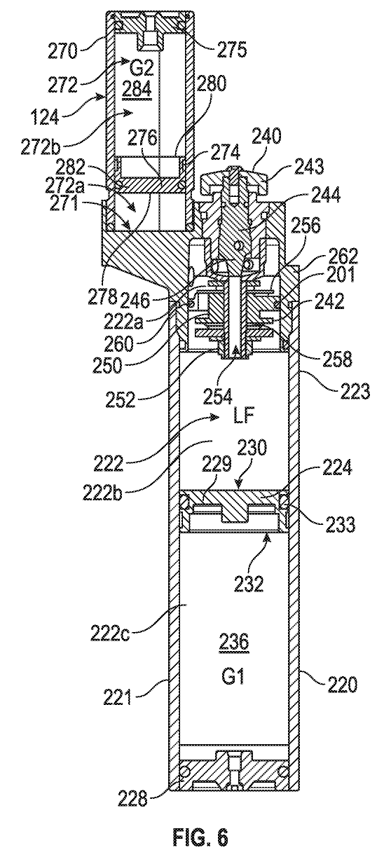

Referring now to FIGS. 4-6, embodiments of first damping system 122 and second damping system 124 are depicted. FIG. 5 is a top view of multi-rate damping shock 104 with a cutting plane line the view of FIG. 6.

In an embodiment, first damping system 122 includes first reservoir body 220 defining first reservoir 222, first floating piston 224 and adjustable valve assembly 226 and end cap 228.

First reservoir body 220, in an embodiment, extends longitudinally, or in an upper-to-lower direction, and in an embodiment forms a generally cylindrical shape. First reservoir body 220 includes first or upper end 221 and second or lower end 223. First reservoir body 220 defines first reservoir 222, which includes fixed-volume portion 222a, first variable-volume reservoir portion 222b and second variable-volume reservoir portion 222c, as will be described further below. Fixed-volume portion 222a and first variable-volume reservoir portion 222b contain liquid fluid LF, while second variable-volume reservoir portion 222c contains a gaseous damping fluid G.

First floating piston 224, as will be described further below, is not connected to a shaft, and is configured to “float” or move longitudinally within first and second variable-volume reservoir portions 222 b and 222c. As first floating piston 224 moves within first reservoir 222, volumes of first and second variable-volume reservoir portions 222b and 222c vary. In an embodiment, first floating piston 224 includes piston body 229 with first or liquid-fluid face 230 and second or gas-fluid face 232. Liquid-fluid face 230 faces toward liquid fluid LF in first variable-volume reservoir 222b and adjustable valve assembly 226, while gas-fluid face 232 faces into second variable-volume reservoir 222c and end cap 228.

First floating piston 224 also includes seal 233 which contacts inside surface 236 of first reservoir body 220. Seal 233 may be, for example, an o-ring that forms a seal between first floating piston 224 and inside surface 236.

Adjustable valve assembly 226 may be referred to as a “piston-clicker” assembly or simply “clicker” assembly that allows a user to adjust a first damping function or damping rate by rotating an external knob to increase or decrease flow restriction through the adjustable valve assembly 226. In an embodiment, adjustable valve assembly 226 includes adjusting portion 240 and valve portion 242.

Adjusting portion 240, in an embodiment, and as depicted, includes external rotatable knob 243 connected to shaft 244, which at its end forms tapered needle portion 246. As will be understood by those of ordinary skill in the art, adjusting portion 240 may include an indexing ball-and-detent structure so that rotation of knob 243 and connected shaft 244 determines predefined rotational positions with movement from one indexed position to another indexed position resulting in audible “clicks.” Rotation of adjusting portion 240 causes needle portion 246 to move longitudinally, affecting flow through valve portion 242.

Valve portion 242 is somewhat similar to main piston assembly 152 in structure and operation, and in an embodiment includes piston body 250, shaft 252 defining needle channel 254, one or more compression shims or valves 256 and one or more rebound shims or valves 258.

Piston body 250 defines compression and rebound ports similar to piston body 200, with the one or more compression shims located atop piston body 250 and regulating flow through compression ports in piston body 250 during a shock compression stroke, and with the one or more rebound shims located at a lower side of piston body 250 and regulating flow through piston body 250 during a shock rebound stroke.

Valve portion 242 is fixedly positioned within first reservoir body 220 and sealed to first reservoir body 220 at seal 260.

A lower portion of valve portion 242 below seal 260, such as a lower portion of piston body 250 and rebound shims 258, is in located in a volume defined as part of first variable volume 222b, which is filled with liquid fluid LF. An upper portion of valve portion 242, such as an upper portion of piston body 250 and compression shims 258, is located within fixed-volume portion 222a of first reservoir 222. Fixed-volume portion 222a is defined by upper portion 262 of first reservoir body 220 and piston flange 201 of piston body 250, and portions of inside surface 236.

First variable-volume reservoir portion 222b is configured to receive liquid fluid LF that may be displaced from shock-body fluid chamber 136. First variable-volume reservoir portion 222b includes the volume between liquid-fluid face 230 of first floating piston 224 and adjustable valve assembly 226, and portions of inside surface 236.

Second variable-volume reservoir portion 222c is configured to receive a first gaseous damping fluid G1 (referred to hereinafter as “first gas G1”), such as, but not limited to, nitrogen gas. Second variable-volume reservoir portion 222c may be charged with first gas G1 to an initial gas pressure GP1. Second variable-volume reservoir portion 222c includes the volume between gas-fluid face 232 and endcap 228, as well as inner surface 236, which may form a cylindrical surface.

As will be described further below, when first floating piston 224 is nearest valve portion 242, such as at an end of a rebound stroke, and when a volume of second variable-volume reservoir portion 222c is at a maximum, a gas pressure GP1 of first gas G1 will be at a minimum pressure, GP1 min. Conversely, as first floating piston 224 moves in a direction away from valve portion 242 and toward end cap 228, the volume of second variable-volume reservoir portion 222c reduces, gas pressure GP1 rises above minimum pressure GP1 min, reaching a maximum pressure GP1 max when first floating piston 224 is furthest from valve portion 242, such as at an end of a compression stroke, and when a volume of second variable-volume reservoir portion 222c is at a minimum.

Consequently, the various components of first damping system 122 provide first damping features or damping rates that contribute to an overall shock damping rate of twin-reservoir shock 104.

Referring to FIGS. 2, 4 and 6, an embodiment of second damping system 124 is depicted. In this embodiment, second damping system 124 includes second reservoir body 270 defining second reservoir 272, second floating piston 274 and end cap 275.

Second reservoir body 270, in an embodiment, extends longitudinally, or in an upper-to-lower direction, and in an embodiment forms a generally cylindrical shape. In other embodiments, second reservoir body 270 may extend in a direction other than longitudinally. Generally second reservoir body 270 may extend in any direction from the bridge as long as it is tied into the fluid pats between the main body and first reservoir. Second reservoir body 270 includes end surface 271 and inner surface 284, which may be a cylindrical surface, and defines second reservoir 272, which includes third variable-volume reservoir portion 272a and fourth variable-volume reservoir portion 272b, as will be described further below. Third variable-volume reservoir portion 272a is configured to contain liquid fluid LF, while fourth variable-volume reservoir portion 272b contains a gaseous damping fluid, “second gas” G2. Fourth variable-volume reservoir portion 272b may be initially charged with second gas G2 at a second gas pressure GP2. In an embodiment, the initial gas pressure GP2 is greater than the initial gas pressure GP1when second variable-volume reservoir portion 222c and fourth variable-volume reservoir portion 272b are at a maximum volume, respectively, i.e., first and second floating pistons 224, 274 are adjacent to bridge portion 138.

Second floating piston 274, as will be described further below, is not connected to a shaft, and is configured to “float” or move longitudinally within second reservoir 272, and within third and fourth variable-volume reservoir portions 272a and 272b. As second floating piston 274 moves within second reservoir 272, respective volumes of third and fourth variable volume reservoir portions 272a and 272b vary. In an embodiment, floating piston 274 includes piston body 276, with first or liquid-fluid face 278, and second or gas-fluid face 280. Liquid-fluid face 278 faces toward liquid fluid LF in third variable-volume reservoir 272, while gas-fluid face 280 faces into fourth variable-volume reservoir 272b and end cap 275.

Second floating piston 274 also includes seal 282 which contacts inside surface 284 of first reservoir body 270. Seal 282 may be, for example, an o-ring that forms a seal between floating piston 274 and inside surface 284.

Third variable-volume reservoir portion 272a is configured to receive liquid fluid LF that may be displaced from shock-body fluid chamber 136 via second bridge channel 174 and bridge channel system 170. Third variable-volume reservoir portion 272a includes the enclosed volume between liquid-fluid face 278 of second floating piston 274, lower end surface 271 and portions of surface 284.

Fourth variable-volume reservoir portion 272b is configured to receive a second gaseous damping fluid G2 (referred to hereinafter as “second gas G2”), such as, but not limited to, nitrogen gas. In an embodiment, second gas G2 is the same type of gas as first gas G1, though in other embodiments, second gas G2 may differ from first gas G1, depending on desired damping characteristics and damping tuning. As will also be described further below, when first floating piston 274 is nearest end surface 271, and when a volume of fourth variable-volume reservoir portion 272b is at a maximum, a gas pressure GP2of the second gas G2 in fourth variable-volume reservoir portion 272b will be at a minimum pressure, GP2 min. Conversely, as second floating piston 274 moves in a direction away from end surface 271 and toward end cap 275, the volume of fourth variable-volume reservoir portion 272b reduces, gas pressure GP2 rises above minimum pressure GP2 min, reaching a maximum pressure GP2max when second floating piston 274 is furthest from end surface 271, closest to end cap 275, and a volume of fourth variable-volume reservoir portion 272b is at a minimum and a volume of third variable-volume reservoir portion 272a is at a maximum.

Consequently, the various components of second damping system 124 provide second damping features or damping rates that contribute to an overall shock damping rate of twin-reservoir shock 104.

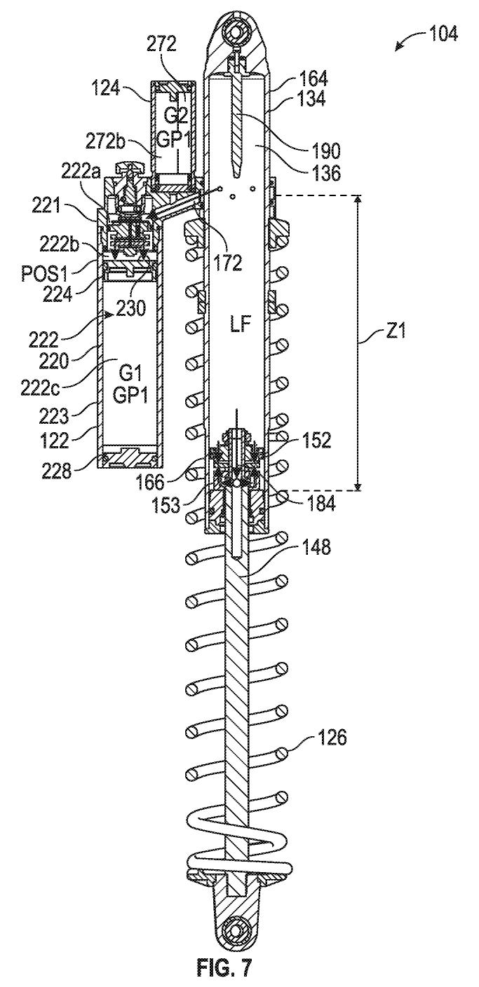

Operation of twin-reservoir shock 104 is described in a series of figures, FIGS. 7-12, which illustrate pistons and valves in various positions during compression and rebound strokes.

Referring specifically to FIG. 7, twin-reservoir shock 104 is depicted in a nearly fully-extended position at the start of a shock compression stroke, with main piston assembly 152 and check valve 153 located at second end 166 of shock body 134. First variable-volume reservoir portion 222b of second reservoir 222 is at its minimum volume, second variable-volume reservoir portion 222c is at its maximum volume, first gas G1 is at first gas pressure GP1 min, which is a minimum pressure. Third variable-volume reservoir portion 272a of second reservoir 272 is at its minimum volume, which is substantially zero as depicted, while fourth variable-volume reservoir portion 272b is at its maximum volume, with second gas G2 at second gas pressure GP2 min, which is a minimum pressure.

As spring 126 begins to be compressed, shaft 148 and its connected main piston assembly 152 and check valve 153 begin to move in a lower-to-upper direction toward first end 164 of shock body 134 and needle 190. With the compression of spring 126 and upward movement of main piston assembly 152 and check valve 153, liquid fluid LF begins to move and flow within twin-reservoir shock 104. Liquid fluid LF flow through pistons, valves and ports is depicted by arrows in FIG. 7.

More specifically, liquid fluid LF in shock-body fluid chamber 136 flows into and through main piston assembly 152 and check valve 153, including liquid fluid LF flowing through piston ports 208 and liquid fluid LF flowing through needle-receiving channel 184 to shaft fluid ports 186 through check valve ports 210 (also see FIG. 4).

Referring also to FIG. 6, at the same time, liquid fluid LF begins to flow out of shock-body fluid chamber 136, through the one or more first bridge channels 172, into fixed-volume reservoir portion 222a, through adjustable valve 226 and into first variable-volume reservoir portion 222b of first reservoir portion 222. The flow of liquid fluid LF into first variable-volume reservoir portion 222b applies fluid pressure to liquid-fluid face 230 of first floating piston 224 causing first floating piston 224 to move in a downward direction toward end cap 228, thereby shrinking the volume of second variable-volume reservoir portion 222c and increasing gas pressure GP1 of first gas G1. First floating piston 224 is depicted at a first position POS1.

Movement of main piston assembly 152 and check valve 153 from a fully-extended position (as substantially depicted in FIG. 7) to a partially-compressed state where main piston assembly 152 and check valve 153 are positioned to close off the one or more first bridge channels 172 defines first damping zone Z1 resulting in a first shock damping rate, depicted as a range of main piston assembly 152 motion in FIG. 7.

When twin-reservoir shock 104 is operated in first damping zone Z1, damping is determined by fluid flow and control through main piston assembly 152 and check valve 153 along with fluid flow and control to and within first damping system 122.

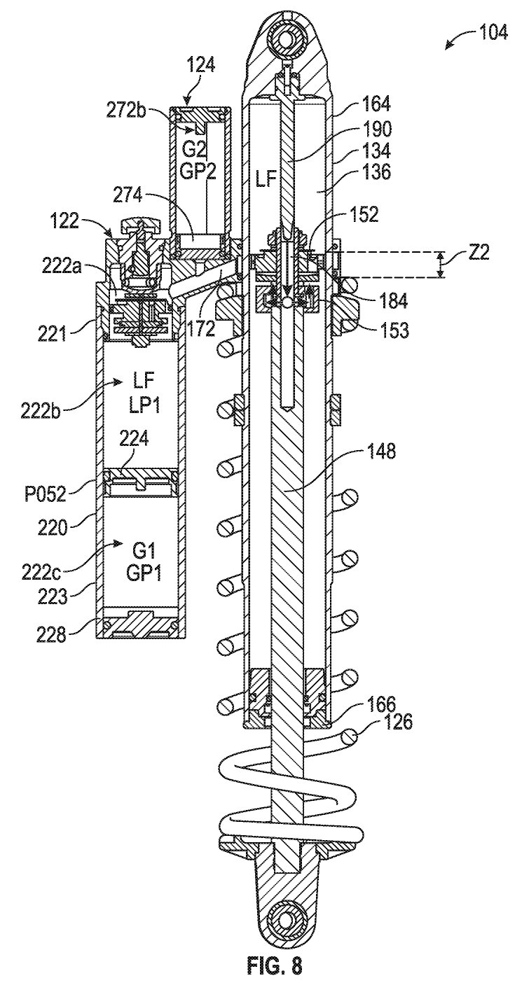

Referring to FIG. 8, twin-reservoir shock operating in second damping zone Z2 is depicted. Operation of twin-reservoir shock 104 in the piston movement range corresponding to second damping zone Z2 yields less or slower damping rates as compared to first damping zone Z2.

In second damping zone Z2 as depicted, main piston assembly 152 and check valve 153 are positioned near an end of a compression stroke and are at or near openings to bridge channel 172, preventing or minimizing, i.e., restricting, flow through bridge channel 172. First floating piston 224 has been displaced to a position POS2, which is closer to end cap 228 and second end 223 as compared to POS1 of FIG. 7 due to liquid fluid LF flow into first variable-volume reservoir portion 222b during compression during first damping zone Z1, which increases a pressure LP1 in second variable-volume reservoir portion 222b to be above gas pressure GP1, resulting in movement of piston 224.

Although no flow of liquid fluid LF into bridge channel 172 is indicated by arrows in FIG. 8 within second damping zone Z2 due to restriction of bridge channel 172 by main piston assembly 152, it will be understood that some liquid fluid LF may flow into bridge channel 172 and first damping system 122 during operation within second damping zone Z2, depending on the extent that bridge channel 172 is restricted.

As main piston assembly 152 approaches needle 190 in second damping zone Z2, needle-receiving channel 184 becomes adjacent to the tapered end of needle 190, and may begin to receive a portion of needle 190. However, during operation in zone 2, fluid LF flows through needle-receiving channel 184 and through check valve 153. Liquid fluid LF also flows through main piston assembly 152 as also indicated by the flow arrows of FIG. 8.

During operation in second damping zone Z2, second damping system 124 does not contribute to overall shock damping as pressure on piston 274 is not sufficient to overcome the relatively high gas pressure GP2 in fourth variable-volume reservoir portion 272b.

Consequently, first damping system 122 contributes minimal damping effect in second damping zone Z2, such that a second damping rate in second damping zone Z2 is different than the first damping rate in first damping zone Z1. With reduced damping rates in second damping zone Z2, compression speeds will be slower, resulting in a firmer ride for vehicle 100.

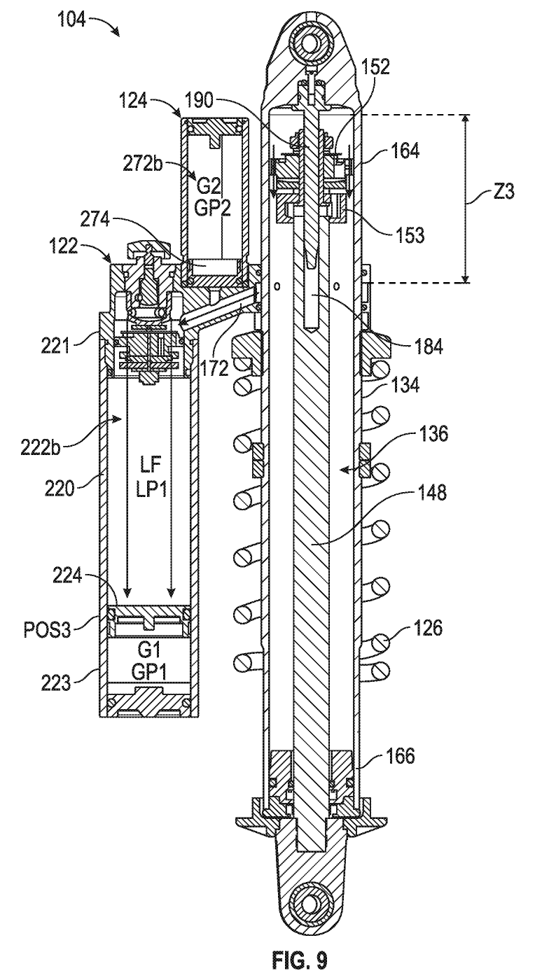

Referring to FIG. 9, twin-reservoir shock 104 operating in third damping zone Z3 is depicted. Operation of twin-reservoir shock 104 in the piston movement range corresponding to third damping zone Z3 yields even less or slower damping rates as compared to second damping zone Z2, resulting in an even firmer vehicle 100 ride.

In third damping zone Z3 as depicted, twin-reservoir shock 104 is fully, or nearly-fully compressed, such that main piston assembly 152 and check valve 153 are at first end 164 of shock body 134 and are not blocking or restricting bridge channel 172. Consequently, liquid fluid LF continues to flow through bridge channel 172 and into first damping system 122 during the compression stroke occurring in third damping zone Z3, thereby moving piston 224 further towards second end 223, and further compressing gas fluid G1 to a higher gas pressure GP1.

During operation in third damping zone Z3, needle 190 is located in needle-receiving channel 184 of shaft 148, moving deeper into shaft 148 and needle-receiving channel 184 as the compression stroke nears a maximum compressed state. With needle 190 in needle-receiving channel 184, liquid fluid LF cannot flow through shaft 148 and needle-receiving channel 184 and through check valve 143, which reduces a damping effect.

Liquid fluid LF flows through main piston assembly 152 as indicated by the flow arrows.

Also during operation in third damping zone Z3, second damping system 124 does not contribute to overall shock damping as pressure on piston 274 is not sufficient to overcome the relatively high gas pressure GP2 in fourth variable-volume reservoir portion 272b.

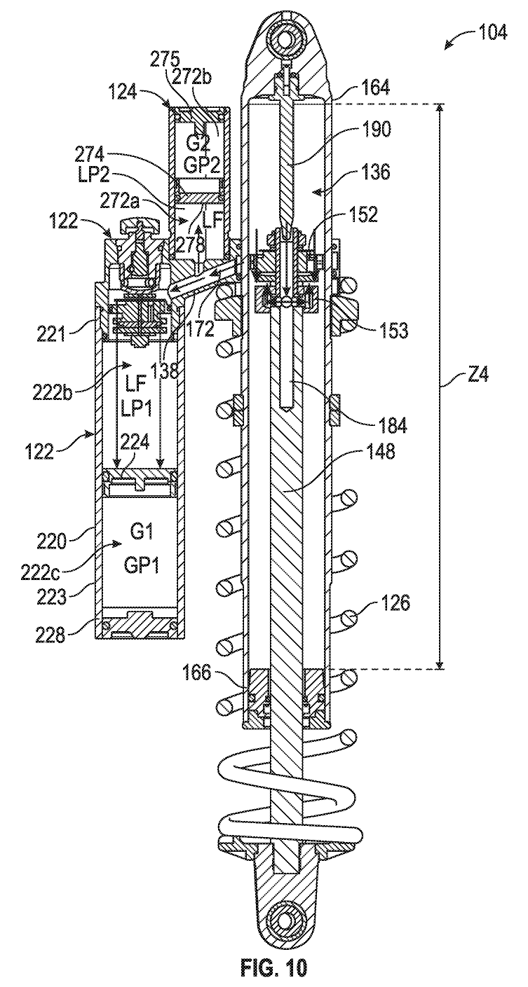

Damping zones Z1, Z2 and Z3 respectively correspond to certain ranges of movement of main piston assembly 152 and check valve 153 over only a portion of the length of shock-body fluid chamber 136 as depicted in FIGS. 7-9. In contrast, and referring to FIG. 10, fourth damping zone Z4 potentially corresponds to movement of main piston assembly 152 and check valve 153 over the entire, or substantially the entire, range of motion of man piston assembly 152 and check valve through shock-body fluid chamber 136, but only when twin-reservoir shock 104 is subject to rapid compression as explained further below. The additional damping effect of fourth zone 4 is implemented by operation of second damping system 124.

In an instance when twin-reservoir shock 104 is subjected to a “spike load” in shaft velocity, second damping system 124 will add additional damping to twin-reservoir shock 104. A “spike load” refers to a very rapid acceleration and/or velocity of shaft 148 with piston assembly 152 and check valve 153 moving toward first end 164. This rapid movement of shaft 148 and connected piston assembly 152 and check valve 153 creates a rapid increase in fluid flow and fluid pressure in shock-body fluid chamber 136, in the one or more first bridge channels 172 and the one or more second bridge channels 174, and subsequently, at liquid-fluid face 278 of second floating piston 274. This rapid increase in pressure causes liquid-fluid LF to flow into third variable-volume reservoir portion 272a via the one or more second bridge channels 174, causing second piston assembly 274 to move upwardly and away from bridge portion 138 and toward and cap 275, compressing second gas G2 and increasing second gas pressure GP2, thereby providing additional damping.

At the same time, and as described above with respect to first, second and third damping zones Z1, Z2 and Z3 respectively, liquid fluid LF will flow through one or more of main piston assembly 152 (all damping zones Z1-Z3), check valve 153 (damping zones Z1 and Z2), first damping system 122 (damping zones Z1 and Z2 and less so for damping zone Z3). In other words, fourth damping zone Z4 provides additional damping for each of damping zones Z1 to Z3, when shaft 148 is subjected to sufficiently rapid acceleration and/or velocity.

In an embodiment, second floating piston 274 will displace prior to first floating piston 224 when twin-reservoir shock 104 is subjected to a spike load.

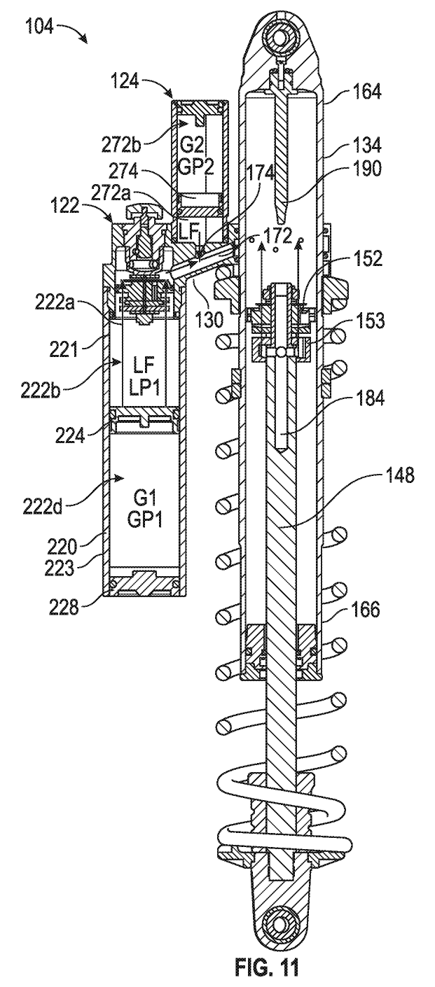

Referring to FIG. 11, a rebound stroke of twin-reservoir shock 104 and resetting of second damping system 124 is depicted.

Following a compression stroke, and during a rebound stroke, shaft 148 and connected main piston assembly 152 and check valve 153 move in a downward direction, away from first end 164 and toward second end 166. As indicated by the flow arrows, liquid fluid LF flows through main piston assembly 152, in an opposite direction, which is towards first end 164 of shock body 134.

During the rebound stroke, and as indicated by the flow arrows, liquid fluid LF flows out of first variable-volume reservoir portion 222b, through fixed-volume reservoir portion 222a, through the one or more first bridge channels 172 and back into shock-body fluid chamber 136. First floating piston 224 moves upwardly toward first end 221 of first reservoir body 220; gas pressure GP1decreases; second variable-volume reservoir portion 222c increases in volumetric size; and first variable-volume reservoir portion 222b decreases in volumetric size.

Also during the rebound stroke, and as depicted by the flow arrows, liquid fluid LF flows out of third variable-volume reservoir portion 272a, through the one or more second bridge channels 174, through the one or more first bridge channels 172 and into shock-body fluid chamber 136. Second floating piston 274 moves downwardly toward bridge portion 138; third variable-volume reservoir portion 272a decreases in volumetric size, fourth variable-volume reservoir portion 222a increases in volumetric size; and gas pressure GP2 decreases.

At the end of a fully-extended rebound stroke when spring 126 is not compressed, shaft 148 with connected main piston assembly 152 and check valve 153 are moved to be adjacent to end 166, first floating piston 224 is positioned at first end 221 of first reservoir body 220, and second floating piston 274 is located adjacent to end surface 271 and bridge portion 138.

The following clauses illustrated example subject matter described herein.
Clause 1. A twin-reservoir shock absorber that includes: a shock body defining a longitudinally-extending shock-body fluid chamber; a shaft insertable into the shock-body fluid chamber, the shaft having a first end and a second end; a piston connected to the first end of the shaft and longitudinally moveable within the shock-body fluid chamber; a first damping system including a first reservoir body and a first floating piston in the first reservoir body, the first reservoir body defining a first reservoir, the first reservoir having a first variable-volume reservoir portion in fluid communication with the shock-body fluid chamber, and a second variable-volume reservoir portion reservoir filled with a first gas, the first floating piston separating the first variable-volume reservoir portion from the second variable-volume reservoir portion; a second damping system including a second reservoir body and a second floating piston in the second reservoir body, the second reservoir body defining a second fluid reservoir, the second fluid reservoir including a third variable-volume reservoir portion in fluid communication with the shock-body fluid chamber and a fourth variable-volume reservoir portion filled with a second gas, the second floating piston separating the second variable-volume fluid reservoir from the second variable-volume gas reservoir; and a spring extending over a portion of the shock body.
Clause 2. The twin-reservoir shock absorber of clause 1, wherein a gas pressure of second gas in the second variable-volume fluid reservoir is greater than a gas pressure of first gas in the first variable-volume fluid reservoir when the shaft assembly is in a fully-extended position.
Clause 3. The twin-reservoir shock absorber of clause 2, wherein the first gas and the second gas comprise nitrogen gas.
Clause 4. The twin-reservoir shock absorber of one of clauses 1 to 3, wherein the first damping system further includes an adjustable valve assembly.
Clause 5. The twin-reservoir shock absorber of one of clauses 1 to 4, wherein the adjustable valve assembly is configured to adjust a shock rebound speed.
Clause 6. The twin-reservoir shock absorber of clause 1, further comprising a bridge portion mechanically connecting the shock body to the first damping system and the second damping system.
Clause 7. The twin-reservoir shock absorber of clause 6, wherein the bridge portion defines a bridge channel system fluidly connecting the shock-body fluid chamber to the first damping system and to the second damping system.
Clause 8. The twin-reservoir shock absorber of clause 8, where the bridge channel system includes one or more first bridge channels fluidly connecting the shock-body fluid chamber to the first damping system and fluidly connecting the shock-body fluid chamber to the second damping system via one or more second bridge channels.
Clause 9. The twin-reservoir shock absorber of clause 1, wherein the first damping system is configured to dampen compression of the spring at a first damping rate and the second damping system is configured to dampen compression of the spring at a second damping rate.
Clause 10. The twin-reservoir shock absorber of clause 9, wherein the first damping rate is greater than the second damping rate.
Clause 11. The twin-reservoir shock absorber of clause 1, wherein the spring is a dual-rate coil over spring that includes a first spring with a first spring rate and a second spring with a second spring rate.
Clause 12. A multirate shock absorber system that includes: a shock body assembly, including a shock body defining a shock-body fluid chamber filled with a liquid fluid, a shaft moveable within the shock-body fluid chamber, a main piston assembly and a check valve connected to the shaft, and a spring coupled to the shock body; a first damping system in fluid communication with the shock-body assembly, the first damping system configured to dampen movement of the spring according to a first damping rate of the first damping system; and a second damping system in fluid communication with the shock-body assembly, the first damping system configured to dampen movement of the spring according to a second damping rate of the second damping system, the first damping rate being greater than the second damping rate.
Clause 13. The multirate shock absorber system of clause 12, wherein the multirate shock absorber is configure to operate in a plurality of shock compression damping zones, each shock compression damping zone corresponding a unique shock damping rate.
Clause 14. The multirate shock absorber system of clause 13, wherein the plurality of shock damping zones comprises a first, second and third shock compression damping zone, the first shock compression damping zone corresponding with a fastest shock compression damping rate and the third damping shock compression damping zone corresponding to a slowest shock compression damping rate.
Clause 15. The multirate shock absorber system of clause 14, wherein the second damping system does not contribute to damping movement of the multirate shock absorber in the plurality of shock compression damping zones.
Clause 16. The multirate shock absorber system of clause 14, wherein the second damping system does contributes to damping movement of the multirate shock absorber in each of the plurality of shock compression damping zones.
Clause 17. The multirate shock absorber system of clause 12, wherein the first damping system defines a first reservoir with a first variable-volume reservoir portion configured to receive liquid fluid and a second variable-volume reservoir portion configured to receive a first gas, and the second damping defines a second reservoir with a third variable-volume reservoir portion configured to receive liquid fluid and a fourth variable-volume reservoir portion configured to receive a second gas.
Clause 18. The multirate shock absorber of clause 17, wherein a first gas pressure of the first gas in the second variable-volume reservoir portion is less than a second gas pressure of the second gas in the fourth variable-volume reservoir portion.
Clause 19. A powersports vehicle that includes: a vehicle body; a plurality of ground-engaging members; a power source connected to a transmission for propelling the powersports vehicle, a suspension system including a plurality of twin-reservoir shock absorbers; and a frame supporting the vehicle body, power source and transmission, and suspension system. Each twin-reservoir shock absorber of the plurality of shock-absorbers includes: a shock body defining a longitudinally-extending shock-body fluid chamber; an axially-extending shaft insertable into the shock-body fluid chamber, the shock shaft having a first end and a second end; a piston connected to the first end of the shaft and longitudinally moveable within the shock-body fluid chamber; a first damping system including a first reservoir body defining a first reservoir and a first floating piston in the first reservoir, the first damping system configured to provide a first shock damping effect; and a second damping system including a second reservoir body defining a second reservoir and a second floating piston in the second reservoir, the second damping system configured to provide a second shock damping effect that is different from the first shock damping effect.
Clause 20. The powersports vehicle of clause 19, wherein the first reservoir has a first gas-filled reservoir portion having a gas at a first gas pressure and the second reservoir has a second gas-filled reservoir portion having a second gas at a second gas pressure, the second gas pressure being greater than the first gas pressure.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A twin-reservoir shock absorber, comprising:
a shock body defining a longitudinally-extending shock-body fluid chamber;
a shaft insertable into the shock-body fluid chamber, the shaft having a first end and a second end;
a piston connected to the first end of the shaft and longitudinally moveable within the shock-body fluid chamber;
a first damping system including a first reservoir body and a first floating piston in the first reservoir body, the first reservoir body defining a first reservoir, the first reservoir having a first variable-volume reservoir portion in fluid communication with the shock-body fluid chamber, and a second variable-volume reservoir portion filled with a first gas, the first floating piston separating the first variable-volume reservoir portion from the second variable-volume reservoir portion;
a second damping system including a second reservoir body and a second floating piston in the second reservoir body, the second reservoir body defining a second fluid reservoir, the second fluid reservoir including a third variable-volume reservoir portion in fluid communication with the shock-body fluid chamber and a fourth variable-volume reservoir portion filled with a second gas, the second floating piston separating the second variable-volume fluid reservoir from the second variable-volume gas reservoir; and
a spring extending over a portion of the shock body.

2. The twin-reservoir shock absorber of claim 1, wherein a second gas pressure of the second gas in the second variable-volume fluid reservoir is greater than a first gas pressure in the first variable-volume fluid reservoir when the shaft assembly is in a fully-extended position.

3. The twin-reservoir shock absorber of claim 2, wherein the first gas and the second gas comprise nitrogen gas.

4. The twin-reservoir shock absorber of one of claim 1, wherein the first damping system further includes an adjustable valve assembly.

5. The twin-reservoir shock absorber of one of claim 4, wherein the adjustable valve assembly is configured to adjust a shock rebound speed.

6. The twin-reservoir shock absorber of claim 1, further comprising a bridge portion mechanically connecting the shock body to the first damping system and the second damping system.

7. The twin-reservoir shock absorber of claim 6, wherein the bridge portion defines a bridge channel system fluidly connecting the shock-body fluid chamber to the first damping system and to the second damping system.

8. The twin-reservoir shock absorber of claim 7, where the bridge channel system includes one or more first bridge channels fluidly connecting the shock-body fluid chamber to the first damping system and fluidly connecting the shock-body fluid chamber to the second damping system via one or more second bridge channels.

9. The twin-reservoir shock absorber of claim 1, wherein the first damping system is configured to dampen compression of the spring at a first damping rate and the second damping system is configured to dampen compression of the spring at a second damping rate.

10. The twin-reservoir shock absorber of claim 9, wherein the first damping rate is greater than the second damping rate.

11. The twin-reservoir shock absorber of claim 1, wherein the spring is a dual-rate coil over spring that includes a first spring with a first spring rate and a second spring with a second spring rate.

12. A multirate shock absorber system, comprising:
a shock body assembly, including a shock body defining a shock-body fluid chamber filled with a liquid fluid, a shaft moveable within the shock-body fluid chamber, a main piston assembly and a check valve connected to the shaft, and a spring coupled to the shock body;
a first damping system in fluid communication with the shock-body assembly, the first damping system configured to dampen movement of the spring according to a first damping rate of the first damping system; and
a second damping system in fluid communication with the shock-body assembly, the first damping system configured to dampen movement of the spring according to a second damping rate of the second damping system, the first damping rate being greater than the second damping rate.

13. The multirate shock absorber system of claim 12, wherein the multirate shock absorber is configured to operate in a plurality of shock compression damping zones, each shock compression damping zone corresponding a shock damping rate.

14. The multirate shock absorber system of claim 13, wherein the plurality of shock damping zones comprises a first, second and third shock compression damping zone, the first shock compression damping zone corresponding to a fastest shock compression damping rate and the third damping shock compression damping zone corresponding to a slowest shock compression damping rate.

15. The multirate shock absorber system of claim 14, wherein the second damping system does not contribute to damping movement of the multirate shock absorber in the plurality of shock compression damping zones.

16. The multirate shock absorber system of claim 14, wherein the second damping system does contributes to damping movement of the multirate shock absorber in each of the plurality of shock compression damping zones.

17. The multirate shock absorber system of claim 12, wherein the first damping system defines a first reservoir with a first variable-volume reservoir portion configured to receive liquid fluid and a second variable-volume reservoir portion configured to receive a first gas, and the second damping defines a second reservoir with a third variable-volume reservoir portion configured to receive liquid fluid and a fourth variable-volume reservoir portion configured to receive a second gas.

18. The multirate shock absorber of claim 17, wherein a first gas pressure of the first gas in the second variable-volume reservoir portion is less than a second gas pressure of the second gas in the fourth variable-volume reservoir portion.

19. A powersports vehicle, comprising:
a vehicle body;
a plurality of ground-engaging members;
a power source connected to a transmission for propelling the powersports vehicle,
a suspension system including a plurality of twin-reservoir shock absorbers; and
a frame supporting the vehicle body, power source and transmission, and suspension system;
wherein each twin-reservoir shock absorber of the plurality of shock-absorbers includes:
a shock body defining a shock-body fluid chamber;
an axially-extending shaft insertable into the shock-body fluid chamber, the shock shaft having a first end and a second end;
a piston connected to the first end of the shaft and longitudinally moveable within the shock-body fluid chamber;
a first damping system including a first reservoir body defining a first reservoir and a first floating piston in the first reservoir, the first damping system configured to provide a first shock damping effect; and
a second damping system including a second reservoir body defining a second reservoir and a second floating piston in the second reservoir, the second damping system configured to provide a second shock damping effect that is different from the first shock damping effect.

20. The powersports vehicle of claim 19, wherein the first reservoir has a first gas-filled reservoir portion having a first gas at a first gas pressure and the second reservoir has a second gas-filled reservoir portion having a second gas at a second gas pressure, the second gas pressure being greater than the first gas pressure.
